(19) United States
(12) Patent Application Publication
(10) Pub. No.: US 2010/0043275 A1
(43) Pub. Date: Feb. 25, 2010

(54) Entrapping crawling insects sevice

(76) Inventor: Antonio Washington Battick, West Hempstead, NY (US)

Correspondence Address: Antonio Battick, 289 Colonial rd, West Hempstead, NY, 11552, US

(21) Appl. No.: 12/384,846

(22) Filed: Apr. 9, 2009

Related U.S. Application Data
(63) Continuation-in-part of application No. 12/229,013, filed on Aug. 19, 2008.

(51) Int. Cl. A01M 1/14; A01M 1/00; A01M 1/20

(52) U.S. Cl. 43/114; 43/131

(57) ABSTRACT

A device for entrapping crawling insects such as bed bugs, ants, spiders, etc. is disclosed. The device generally includes an elongated strip having at least one cavity longitudinally propagating along the strip and an insect-immobilizing substance disposed in the cavity. In embodiments, the strip may be fabricated for affixing and/or snug or snap fitting to objects being protected from the crawling insects, and the cavities may contain adhesives (e.g., gelatinous-based adhesives), pesticides, or a combination thereof.

### CROSS-REFERENCE TO RELATED PATENT APPLICATIONS

This application is a continuation-in-part of co-pending U.S. patent application Ser. No. 12/229,013, filed on Aug. 19, 2008, which is herein incorporated by reference.

### FIELD OF THE INVENTION

The present invention relates generally to the field of pest control and, more specifically, to a device for entrapping crawling insects such as bed bugs, ants, spiders, and the like.

### BACKGROUND OF THE INVENTION

In domestic settings, bed bugs, along with other biting or blood-sucking crawling insects, represent significant threat to the health and well being of humans and their pets. In recent years, a noticeable resurgence of such insects and, in particular, bed bugs has been observed worldwide.

In living and public spaces, bed bugs may infest beds (e.g., box springs, mattresses, headboards, frames, etc.), upholstered and non-upholstered furniture, picture frames, household and kitchen appliances, carpets, openings in wall and floors, and the like areas and devices. Protection from bed bugs and other crawling insects has proved to be a challenging task.

### SUMMARY OF THE INVENTION

A device for entrapping crawling insects (e.g., bed bugs, ants, spiders, and the like) is disclosed.

In one embodiment, the device generally comprises an elongated insect-entrapping strip having at least one longitudinal cavity propagating along the strip and an insect-immobilizing substance, which is disposed in the cavity. In operation, each such cavity performs as a trap for the crawling insects. Portions of the strip may be fabricated from elastic, non-elastic, or shape-memory materials. The strip may be adapted for snug or snap fitting or otherwise affixing to objects being protected by the device from crawling insects (for example, objects such as mattresses, furniture, appliances, etc.). The insect-immobilizing substance includes adhesives, pesticides, or a combination thereof and, in operation, entraps and kills the insects.

All objects, features and advantages of the present invention will become apparent in the following detailed written description and appended drawings. It has been contemplated that features of one embodiment of the invention may be incorporated in other embodiments thereof without further recitation.

The summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

FIG. 1 depicts a device for entrapping crawling insects according to one embodiment of the invention (illustratively, the device is shown being installed on an exemplary bedding set).

FIGS. 2A-2B depict cross-sectional views of an exemplary insect-entrapping strip of the device of FIG. 1 according to some embodiments of the invention.

FIGS. 3A-3E depict cross-sectional views of exemplary insect-entrapping strips of the device of FIG. 1 according to alternate embodiments of the invention.

FIG. 4 depicts an exemplary configuration for coupling opposing ends of an insect-entrapping strip of the device of FIG. 1 according to one embodiment of the invention.

The images in the drawings are simplified for illustrative purposes and are not depicted to scale. To facilitate understanding, identical reference numerals are used, where possible, to designate substantially identical elements that are common to the figures, except that alphanumerical extensions and/or suffixes may be added, when appropriate, to differentiate such elements.

### DETAILED DESCRIPTION

The present invention provides a device for entrapping crawling insects. The invention may advantageously be utilized in private, commercial, and public living spaces and settings, including but not limited to residencies, hotels, restaurants, food-processing plants, and the like. Particularly advantageous the invention may be utilized for entrapping bed bugs.

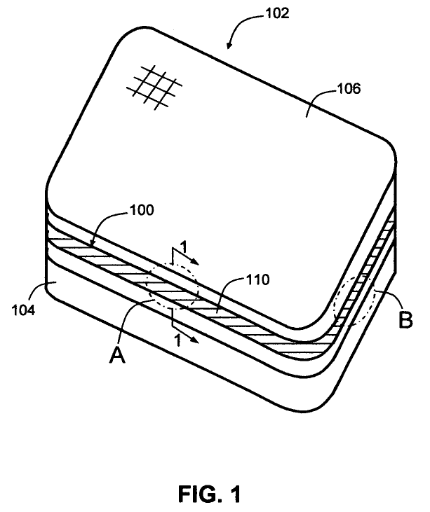

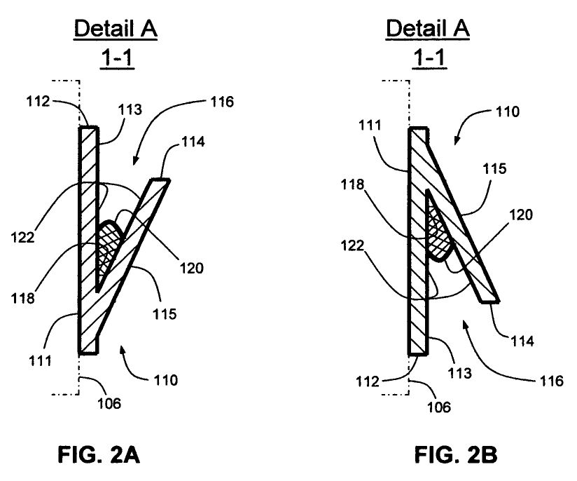

With reference now to the figures, and specifically with reference to FIG. 1, there is depicted a device 100 for entrapping crawling insects (for example, bed bugs, ants, spiders, and the like) according to one embodiment of the invention. The device 100 generally includes an elongated insect-entrapping strip 110 and an insect-immobilizing substance 120 (shown in FIGS. 2A-2B). Illustratively, the device 100 is shown being installed on an exemplary bedding set 102, which includes a frame (or box spring) 104 and a mattress 106.

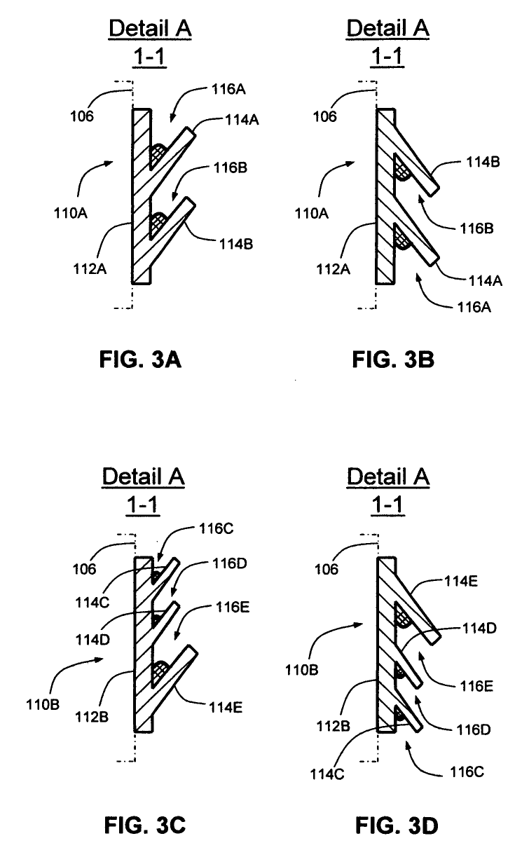

Exemplary embodiments of the device 100 are illustrated in FIGS. 2A-2B and FIGS. 3A-3E, which schematically depict cross-sectional views of a region A (shown in FIG. 1) of the strip 110 and strips 110A-110C, respectively. The cross-sectional views are taken along an arbitrary line 1-1 disposed perpendicular to the strip 110. Those skilled in the art will appreciate that multiple equivalent embodiments of the device 100 may readily be devised using the teachings disclosed therein.

Referring to FIG. 2A, in one embodiment the strip 110 comprises a first wall 112 and a second wall 114, which both propagate along the strip. The second wall 114 is disposed on a front surface 113 of the first wall 112 and, together with the wall 112, defines a longitudinal cavity (or recess) 116 propagating along the strip 110. In alternate embodiments, the second wall 114 may be an extension of the first wall 112, as well as a portion of or an attachment thereto. In a further embodiment (not shown), in at least some regions the strip 110 may comprise projections transversely disposed in the cavity 116 to define and/or limit widths thereof.

In applications, the strip 110 may be installed on an object being protected from the insects (e.g., mattress 106) in a manner providing that the cavity 116 is disposed in any arbitrarily selected direction. Illustratively, FIGS. 2A-2B depict installations of the strip 110 in which the cavity 116 has opposite spatial orientation.

In the depicted embodiments, the first and second walls 112, 114 are illustratively shown as substantially flat walls forming V-shaped cavities (recesses) 116. It has been contemplated and is within the scope of the present invention that the walls 112, 114 may be non-flat walls or walls having different and/or varying cross-sectional dimensions (i.e., thicknesses or widths) and that such walls may define cavities 116 having various cross-sectional configurations.

The insect-immobilizing substance 120 is disposed in cavity 116, wherein the substance may be applied to a bottom portion 118 of the cavity (as shown), sidewalls 122 of the cavity 116, or to both the bottom portion 118 and sidewalls 122.

Dimensions of the cavity 116 are generally selected to be sufficiently large for (i) preventing the insects from crossing a gap between the first and second walls 112 and 114 without entering the cavity 116, and (ii) forcing the insects to crawl along the sidewalls 122 towards the bottom portion 118 of the cavity 116.

Additionally, dimensions and/or cross-sectional configuration of the cavity 116 may be chosen such that a contact between the substance 120 and skin, clothing, or household articles of a user of the device 100 is avoided or prevented (for example, contact with sheets (not shown) disposed on the mattress 106, etc.).

In operation, in an attempt to reach a destination of interest (e.g., a human or a pet residing on the mattress 106), insects coming from beneath the device 100 crawl into the cavity 116 over the second wall 114 (FIG. 2A) or along the first wall 112 (FIG. 2B). In the cavity 116 as a result of entrapping, poisoning, or both, the insects become immobilized and thereafter killed by the substance 120.

Referring to FIG. 2A, insects coming from beneath the strip 110 enter the cavity 116 by crawling along an outer surface 115 of the second wall 114, and insects coming from above the strip 110 enter the cavity 116 by crawling along a front surface 113 of the first wall 112. Correspondingly, in the embodiment depicted in FIG. 2B, insects coming from beneath and above the strip 110 enter the cavity 116 by crawling along the surfaces 113 and 115, respectively.

The first and second walls 112, 114 and the cavity 116 may be formed or defined in the strip 110 during fabrication or assembly of the strip. In the depicted embodiment, the first and second walls 112, 114 are fabricated as a unitary structure. In other embodiments, the second wall 114 may be an extension or a portion of the first wall 112, or the second wall 114 may be attached to the first wall 112 (e.g., using adhesives, hardware, joints, etc.).

It has been contemplated and is within the scope of the present invention that cross-sectional dimensions of the cavity 116 may be selectively optimized for entrapping specific insects (for example, bed bugs) or the strip 110 may include several cavities 116 (discussed in reference to FIGS. 3A-3E) having the same or different cross-sectional dimensions and containing the same or different substances 120.

The strip 110 or portions thereof are generally fabricated from elastic materials, non-elastic materials, and combinations thereof. Illustrative examples of such materials include plastics, resins, compounds, woven and/or non-woven strands or bands, rubber, rubberized and non-rubberized cords, polyurethane (PU), polyvinyl chloride (PVC), wood, metals and alloys, among other materials. In one particular embodiment, at least portions of the strip 110 are manufactured from one or more elastic materials, including stretchable elastic materials (e.g., retractable resins, bungee cords, and the like).

In alternate embodiments, at least portions of the strip 110 may be fabricated from materials adapted for maintaining, during extended time intervals or their operational lifetime, pre-determined form factors. Such materials “memorize” applied deformations and/or shapes of underlying structures and are referred to in the art as “shape-memory materials” and may include, for example, some plastics, polymers, or compounds. These portions of the strip 110 may be pre-formed and/or in-situ adjusted to conform to pre-determined longitudinal form factors (for example, a perimeter of an object being protected from the insects, such as the mattress 106).

Additionally, the strip 110 or portions thereof may be fabricated to conform to surfaces of objects being protected from the insects, such as the mattress 106, frame 104, furniture, picture frames, household or kitchen appliances. For example, a back surface 111 of the first wall 112 may be adapted to conform to the surfaces of these objects.

The substance 120 is adapted for immobilizing and, consequently, killing crawling insects such as bed bugs, ants, and/or spiders, among other crawling insects. In one embodiment, the substance 120 generally comprises at least one adhesive able to entrap the insects, at least one pesticide able to poison the insects, or a combination thereof.

In exemplary embodiments, the substance 120 may include one or several gelatinous-based adhesives, including polybutylene, polyisobutylene, petroleum jelly, and the like adhesives or combinations thereof. Examples of pesticides include pyrethrins, deltamethrim, cyhalothrin or combinations thereof, among other pesticides.

In applications, the substance 120 may be applied to the cavity 116 during manufacture of the device 100 or after installation of the strip 110 on the object being protected from the insects. For example, the substance 120 may be injected or otherwise dispersed in the cavity 116. In some applications, the substance 120 may thereafter be re-applied to the cavity 116 with pre-determined periodicity by a user of the device 100 or pest control personnel.

Referring to FIGS. 3A-3E, the strips 110A-110C may include a plurality of the second walls 114A-114G and cavities 116A-116G having various combinations of the same (strip 110A) and different cross-sectional dimensions (strip 110B) and spatial orientations (strip 110C). Additionally, each of the cavities 116A-116G may comprise the same or different substances 120.

In operation, the strips 110A-110C may be mounted in arbitrarily selected orientations. In the depicted embodiments, the strips 110A and 110B are shown in opposing vertical orientations, and the strip 110C includes oppositely disposed cavities 116. In the depicted embodiments, the back surface 111 (shown in FIGS. 2A-2B) of the first wall 112 is a substantially flat surface. In alternate embodiments, to conform to particular objects, the first walls 112 or portions thereof may have non-flat back surfaces.

In some embodiments, the device 100 comprises the strip 110 having a form factor of a complete loop having a pre-determined length and a pre-determined configuration (e.g., form factor of a rectangular having rounded corner sections, O-ring, etc.). Such device 100 may be adapted for snug or snap fitting to and retaining on an object being protected from the insects (for example, retaining on the mattress 106 or frame 104 by forces of tension, friction, or adhesion). In one particular embodiment, the strip 110 of the device is fabricated from or includes sections fabricated from one or more stretchable elastic materials, such as a bungee cord, resin, and the like.

Alternatively or additionally, to attach the device 100 to an object being protected from the insects, the back surface 111 of the strip 110 may be provided with adhesive or fabric hook-and-loop and the like fasteners. Otherwise, the strip 110 may also be attached to such an object using hardware such as staples, screws, nails, and the like.

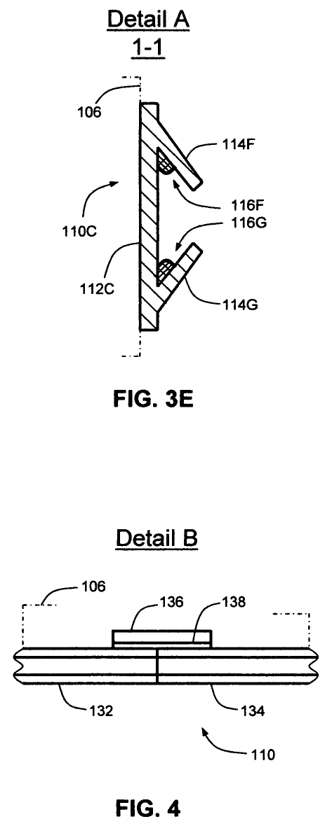

Referring to FIG. 4 depicting a top view of a region B (shown in FIG. 1) of the strip 110, in one alternate embodiment the device 100 comprises the strip 110 having loose opposing ends 132, 134. In one particular embodiment, the device 100 includes a jointing member 136 and an adhesive (or fabric hook-and-loop, etc.) fastener 138 which, in operation, provide coupling of the ends 132 and 134 (illustratively, butt coupling of the ends 132, 134 is shown).

In an alternate embodiment, the ends 132 and 134 may be provided with pre-installed, embedded, or supplemental fasteners (not shown) adapted for coupling the ends to one another or to ends of other such strips (e.g., for butt coupling the ends of the same or different straps 110). Such fasteners may include, for example, hooks, clamps, and the like.

In this embodiment, a strip having a pre-determined length may be formed by connecting, in series, ends of several component strips 110. For example, the length of the strip may be selectively chosen or in-situ adjusted to provide snug or snap fitting to or retaining on the object being protected from the insects.

Although the present invention herein has been described with reference to particular preferred embodiments thereof, it is to be understood that these embodiments are merely illustrative of the principles and applications of the invention. Therefore, modifications may be made to these embodiments and other arrangements may be devised without departing from the spirit and scope of the invention, which is defined by the appended claims.

What is claimed is:

1. A device for entrapping crawling insects, comprising:
an elongated strip, including:
a first wall propagating along the strip and having a front surface and a back surface; and
at least one second wall, said at least one second wall disposed on the front surface and forming with the first wall a cavity propagating along the strip; and
an insect-immobilizing substance disposed in the cavity.

2. The device of claim 1, wherein the first wall and the at least one second wall form a unitary structure.

3. The device of claim 1, wherein the at least one second wall is an extension of the first wall, a portion of the first wall, or an attachment to the first wall.

4. The device of claim 1, wherein:
the cavity in a cross-section has a form factor of a U or V-shaped recess in the strip; and
the back surface of the first wall is adapted to conform to an object being protected from the crawling insects.

5. The device of claim 1, wherein the strip comprises projections adapted to define or limit widths of the cavity.

6. The device of claim 1, wherein the insect-immobilizing substance is adapted for entrapping and/or poisoning the crawling insects including bed bugs, ants, spiders, or a combination of the crawling insects.

7. The device of claim 1, wherein the insect-immobilizing substance comprises at least one adhesive, at least one pesticide, or a combination thereof.

8. The device of claim 1, wherein the insect-immobilizing substance comprises at least one gelatinous-based adhesive.

9. The device of claim 1, wherein the strip is fabricated from elastic materials, non-elastic materials, shape-memory materials, or a combination thereof.

10. The device of claim 1, further comprising fasteners or adhesives adapted for at least one of: (i) coupling ends of the strip to one another or to ends of other such strips and (ii) affixing the strip to an object being protected from the crawling insects.

11. The device of claim 1, wherein the strip is adapted for snug or snap fitting, attaching, or affixing to an object being protected from the crawling insects.

12. The device of claim 1, wherein the strip has a form factor of a ring having a pre-determined length and a pre-determined configuration.

13. A device for entrapping bed bugs, comprising:
an elongated strip, including:
a first wall propagating along the strip and having a front surface and a back surface; and
at least one second wall disposed on the front surface and forming with the first wall a cavity propagating along the strip; and
a bed bugs immobilizing substance disposed in the cavity.

14. The device of claim 13, wherein the first wall and the at least one second wall form a unitary structure or attached to each other or the at least one second wall is an extension of the first wall or a portion of the first wall.

15. The device of claim 13, wherein the substance comprises at least one gelatinous-based adhesive, at least one pesticide, or a combination thereof.

16. The device of claim 13, wherein:
the strip is fabricated from elastic materials, non-elastic materials, shape-memory materials, or a combination thereof; and
the strip is adapted for snug or snap fitting, attaching, or affixing to an object being protected from the bed bugs.

17. The device of claim 13, further comprising fasteners or adhesives adapted for at least one of: (i) coupling ends of the strip to one another or to ends of other such strips, and (ii) affixing the strip to an object being protected from the bed bugs.

18. A device for entrapping crawling insects, said device comprising (i) an elongated strip having at least one longitudinal cavity propagating along the strip and (ii) an insect-immobilizing substance disposed in the at least one cavity.

19. The device of claim 18, wherein:
the strip is (i) fabricated from elastic materials, non-elastic materials, shape-memory materials, or a combination thereof, and (ii) adapted for snug or snap fitting, attaching, or affixing to an object being protected from the bed bugs; and
the substance comprises at least one adhesive and/or at least one pesticide adapted for entrapping or poisoning bed bugs, ants, spiders, or a combination thereof.

20. The device of claim 18, further comprising means adapted for at least one of: (i) coupling ends of the strip to one another or to ends of other such strips, and (ii) affixing the strip to an object being protected from the crawling insects.
